(19) United States
(12) Patent Application Publication
(10) Pub. No.: US 2019/0005030 A1
(43) Pub. Date: Jan. 3, 2019

(54) SYSTEM AND METHOD FOR PROVIDING AN INTELLIGENT LANGUAGE LEARNING PLATFORM

(71) Applicant: EverMem, Inc., Palo Alto, CA (US)

(72) Inventors: Thomas REESE, Palo Alto, CA (US); Yinghua YANG, Palo Alto, CA (US)

(73) Assignee: EverMem, Inc., Palo Alto, CA (US)

(21) Appl. No.: 16/025,165

(22) Filed: Jul. 2, 2018

Related U.S. Application Data
(60) Provisional application No. 62/527,269, filed on Jun. 30, 2017.

(51) Int. Cl. G06F 17/28; G06F 17/27; G06F 17/30; G06N 5/02

(52) U.S. Cl. CPC G06F 17/289; G06N 5/02; G06F 17/3005; G06F 17/2765

(57) ABSTRACT

A system for providing an intelligent language learning platform may be provided. The system may have one or more servers programmed to execute method steps. The steps may include analyzing content on a display of a mobile device or personal computer to identify text in a first language to be translated into a second language for a user to view and learn; displaying a user interface on the display, the user interface including one or more active regions in which a user may actively engage content and/or enter input, the one or more active regions including the text translated in the second language for the user to engage; sensing, in the content active region, a user engaging the translated text; and in response to the user engagement, generating a further content for user engagement.

### CROSS-REFERENCE TO RELATED APPLICATIONS

The present patent application claims benefit and priority to U.S. Patent Application No. 62/527,269 filed on Jun. 30, 2017 which is hereby incorporated by reference into the present disclosure.

### FIELD OF THE INVENTION

The present invention relates to a system and method for providing an intelligent language learning platform.

### BACKGROUND

Learning new languages is a necessary component of multi-cultural human interaction. Various methods of teaching new languages have been employed through human teaching, written text, and computer programs. However, existing methods require a student or user to dedicate time specifically to learning the desired language.

Computers and mobile devices have become an integral part of every-day life for much of the world. Individuals spend a large amount of time completing tasks on computers or mobile devices. There is consequently a desire to learn new languages using such technology with minimal interruption to existing daily activity performed on these devices.

### SUMMARY OF THE INVENTION

According to an exemplary embodiment, a method for providing an intelligent language learning platform may be provided. The method may include accessing content displayed on a device screen, retrieving text and adjacent content shown on the device screen, and retrieving location data for the retrieved text and adjacent content. The retrieved text may be compared to a database of at least one of user data and target words or phrases. At least one target word or phrase may be identified from the comparison. An image of the at least one target word or phrase and its adjacent content may be captured. Subsequently the captured image may be edited to replace the text of the at least one target word or phrase from a first language to a second language. Finally, the edited image may be overlaid on the original content displayed on the device screen to show the text of the at least one target word or phrase in the second language.

According to another exemplary embodiment, a non-transitory computer-readable medium for providing an intelligent language platform may be provided. The non-transitory computer-readable medium may include instructions stored thereon, that when executed on a processor, perform the following steps. Content displayed on a device screen may be accessed, text and adjacent content shown on the device screen may be retrieved, and location data for the retrieved text and adjacent content may be retrieved. The retrieved text may be compared to a database of at least one of user data and target words or phrases. At least one target word or phrase may be identified from the comparison. An image of the at least one target word or phrase and its adjacent content may be captured. Subsequently the captured image may be edited to replace the text of the at least one target word or phrase from a first language to a second language. Finally, the edited image may be overlaid on the original content displayed on the device screen to show the text of the at least one target word or phrase in the second language.

### BRIEF DESCRIPTION OF DRAWINGS

FIG. 1 depicts a block diagram of an example system in which an intelligent language learning platform operates.

FIG. 2 depicts several software application/modules and databases of intelligent language learning platform.

FIG. 3 depicts a flow diagram of method steps for the operation of the intelligent language learning platform.

FIG. 4 depicts a high-level flow diagram of method steps of a user in connection with the method steps in FIG. 3.

FIG. 5 depicts a diagram illustrating attribute created by knowledge engine the intelligent language learning platform.

FIGS. 6A-6B depict flow diagram of the method steps for the operation of the intelligent language learning platform on a mobile device.

FIG. 7 depicts a screenshot illustrating an example webpage incorporating features of the intelligent language learning platform.

FIG. 8 depicts a screenshot illustrating an example webpage incorporating features of the intelligent language learning platform.

FIG. 9 depicts a screenshot illustrating an example webpage incorporating features of the intelligent language learning platform.

FIG. 10 depicts a screenshot illustrating an example webpage incorporating features of the intelligent language learning platform.

FIG. 11 depicts a screenshot illustrating an example webpage incorporating features of the intelligent language learning platform.

FIG. 12 depicts a screenshot illustrating an example webpage incorporating features of the intelligent language learning platform.

FIG. 13 depicts a screenshot illustrating an example webpage incorporating features of the intelligent language learning platform.

FIG. 14 depicts a screenshot illustrating an example webpage incorporating features of the intelligent language learning platform.

FIG. 15 depicts a screenshot illustrating an example webpage incorporating features of the intelligent language learning platform.

FIG. 16 depicts an example flow for the expert user grading market.

FIG. 17A depicts a device screen showing an exemplary feature of the intelligent language learning platform.

FIG. 17B depicts a device screen showing an exemplary feature of the intelligent language learning platform.

FIG. 17C depicts a device screen showing an exemplary feature of the intelligent language learning platform.

FIG. 17D depicts a device screen showing an exemplary feature of the intelligent language learning platform.

FIG. 17E depicts a device screen showing an exemplary feature of the intelligent language learning platform.

FIG. 17F depicts a device screen showing an exemplary feature of the intelligent language learning platform.

FIG. 17G depicts a device screen showing an exemplary feature of the intelligent language learning platform.

FIG. 17H depicts a device screen showing an exemplary feature of the intelligent language learning platform.

FIG. 17I depicts a device screen showing an exemplary feature of the intelligent language learning platform.

FIG. 17J depicts a device screen showing an exemplary feature of the intelligent language learning platform.

FIG. 17K depicts a device screen showing an exemplary feature of the intelligent language learning platform.

FIG. 17L depicts a device screen showing an exemplary feature of the intelligent language learning platform.

FIG. 17M depicts a device screen showing an exemplary feature of the intelligent language learning platform.

FIG. 17N depicts a device screen showing an exemplary feature of the intelligent language learning platform.

FIG. 17O depicts a device screen showing an exemplary feature of the intelligent language learning platform.

### DETAILED DESCRIPTION OF THE INVENTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

The word “exemplary” is used herein to mean “serving as an example, instance, or illustration.” Any embodiment described herein as “exemplary” is not necessarily to be construed as preferred or advantageous over other embodiments Likewise, the term “embodiments of the invention” does not require that all embodiments of the invention include the discussed feature, advantage or mode of operation.

Further, many of the embodiments described herein are described in terms of sequences of actions to be performed by, for example, elements of a computing device. It should be recognized by those skilled in the art that the various sequences of actions described herein can be performed by specific circuits (e.g. application specific integrated circuits (ASICs)) and/or by program instructions executed by at least one processor. Additionally, the sequence of actions described herein can be embodied entirely within any form of computer-readable storage medium such that execution of the sequence of actions enables the at least one processor to perform the functionality described herein. Furthermore, the sequence of actions described herein can be embodied in a combination of hardware and software. Thus, the various aspects of the present invention may be embodied in a number of different forms, all of which have been contemplated to be within the scope of the claimed subject matter. In addition, for each of the embodiments described herein, the corresponding form of any such embodiment may be described herein as, for example, “a computer configured to” perform the described action.

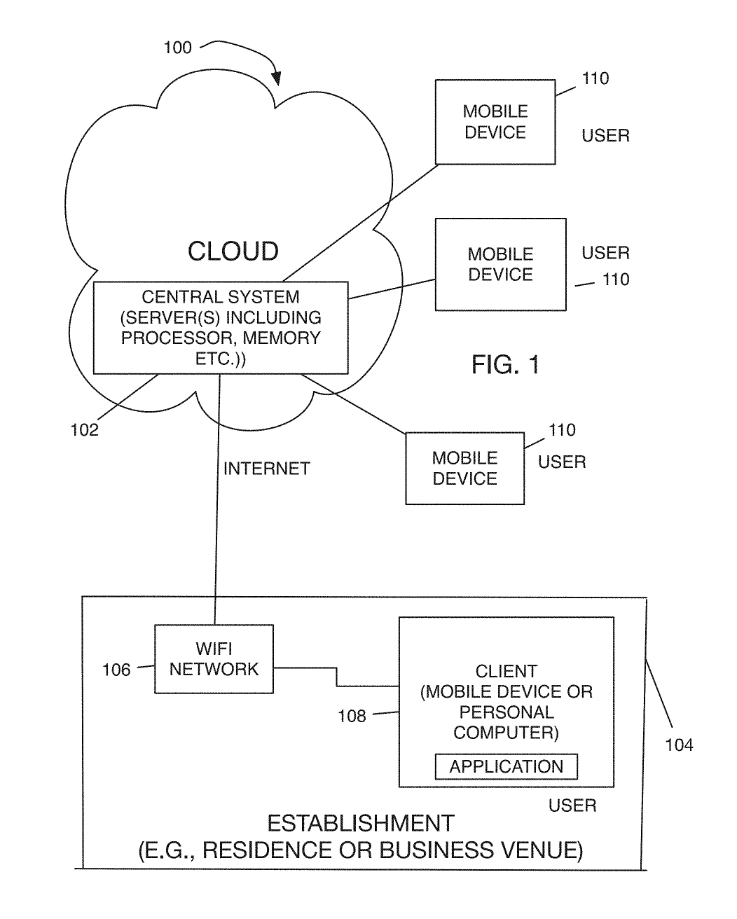

FIG. 1 depicts a block diagram of an example system 100 in which an intelligent language learning platform (200 as identified below) operates. In short, platform 200 integrates language learning in daily browsing activities. In more detail, platform 200 is configured to intelligently and automatically replace one or more words on a webpage in a browser (or other application) from one language into another language that a user desires to learn. Platform 200 is applicable to any client including a personal computer or mobile device. User may also be referred to as a student. (The terms data and information may be used interchangeably herein.)

System 100 includes central system 102 and establishment 104 such as a residence or venue that is configured to access program modules/applications and data (as described below) from central system 102 via a network such as the Internet. Central system 102 is shown in FIG. 1 in the cloud, as known to those skilled in the art. Alternatively, central system 102 may be on a local drive or server. Establishment 104 may communicate with central system 102 over a network, such as the Internet, via a wired connection (e.g., cable, Ethernet) or wirelessly (e.g., WIFI or wireless carrier networks) as known to those skilled in the art. An administrator may access central system 102 through a connected client (not shown) to control the operation of platform 200. This client may be on site or remotely connected to central system 102 over the Internet and/or local area network (LAN). This client may be a personal computer (e.g., desktop or laptop) or display or a mobile device.

Central system 102 comprises one or more servers that are typically connected via a local area network (LAN). The one or more servers may include a web server. Each server includes several internal components (e.g., processor, memory, drives, storage such as hard drives/SSDs, network cards, video cards etc.), operating system, databases, software modules and applications (e.g., browser) as known to those skilled in the art.

Establishment 104 may be home, condominium, townhouse, business or any other venue or place. Establishment 104 comprises, among other components, WIFI network 106 to enable client 108 (i.e., mobile device or personal computer) to access content over the Internet as known to those skilled in the art. However, a user may roam with the mobile device on and off the establishment 106 premises as known to those skilled in the art. System 100 also includes mobile devices 110. Users employ mobile devices 110 to access platform 200. WIFI network 106 is a communication that enables wireless communication to other computers, devices and networks as known to those skilled in the art. Communication may alternatively be performed by Bluetooth, 4G, 5G, or other forms of network communication as would be understood by a person having ordinary skill in the art.

Mobile devices or personal computer (as described herein) each includes several internal components (e.g., processor, memory, drives, storage such as hard drives/SSDs, network cards, sound cards and video cards etc.), operating system, databases, software modules and applications (e.g., browser) as known to those skilled in the art. Mobile device or personal computer 106 or 110, as known to those skilled in the art, incorporates several applications, one of which is used to access modules and features of modules and databases of intelligent language learning platform 200.

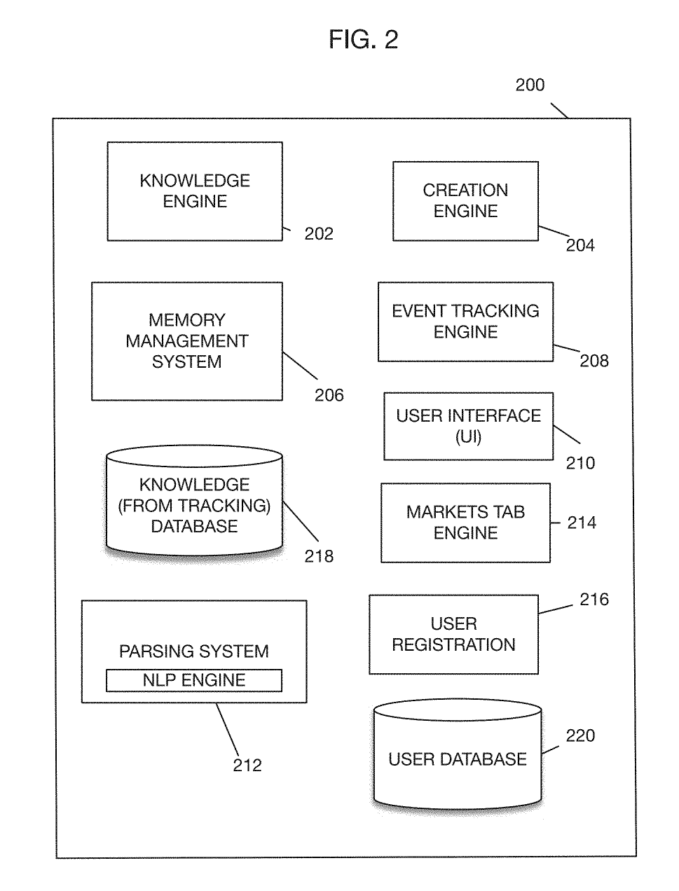

FIG. 2 depicts several software application/modules and databases of intelligent language learning platform 200. Platform 200 includes knowledge engine 202, creation engine 204, memory management system 206, event tracking engine 208, user interface (UI) 210, parsing system 212, markets tab 214, user registration module 216, knowledge database 218 and user database 220.

KNOWLEDGE ENGINE 202. Knowledge engine 202 is a module capable of recording and interpreting a user's (platform 200) usage, knowledge, and learning progress for presenting learning opportunities that best match the target words and tasks. Knowledge engine 202 may continuously interpret and update a data repository of usage statistics. Knowledge engine 202 may communicate with event tracking engine 208 and knowledge database 218. Knowledge engine 202 may trigger (update) certain event tracking performed by event tracking engine 208 to occur based on what knowledge engine 202 learns.

Each language feature (e.g., word, phrase, grammar point, etc.) processed and stored by platform 200 as described below includes any number of attributes such as an interaction timestamp, quiz results, video engagement duration, predicted reading duration, and/or other passive and active events. Each of these may have a weight (weight value) assigned depending on properties, such as the intended type of learning (i.e., writing, speaking, recognition, etc.), progress made, learning frequency and other properties as would be understood by a person having ordinary skill in the art. Some properties may be stored as a list with respect to multiple events and may be reduced to the sum of their weight values. Knowledge engine 202 may select content to display using these weight values in appropriate combinations to match the target words/task. Search may be configured based upon inputs, datasets and desired outcomes. In one example, a search method may select the most relevant of all available language features to teach and then the method to use. In another example, the search method may select from a subset of available features and have pre-defined teaching method restrictions.

For example, if a phrase was very recently typed correctly (by a user), previously read multiple times, not yet spoken, and believed to have been learned based on previous interactions, knowledge engine 202 may assign a low weight value for teaching and typing tasks. However, engine 202 may assign a high weight value for speaking tasks. If the sum of those weight values is greater than the sum of other words' weight values, this word may be selected. According to an exemplary embodiment, if the user then correctly practices speaking after two failed attempts, knowledge engine 202 records each attempt, accuracy, word spoken, recording duration, timestamp, and other properties. It also may have passively recorded when a user first viewed the quiz, that they read the word, the length of the interaction and other properties.

Presenting learning opportunities may trigger immediate and delayed feedback loops within knowledge engine 202 which may then modify old values and add new ones. If engine 202 is re-run immediately after a run, the weight values calculated may be slightly different and will account for additional learning progress or regression. Greater user intent and proof of learning usually equate to more weight value shifts.

CREATION ENGINE 204. Creation engine 204 is a module capable of building lessons dynamically based on content as a user hovers over an inserted user interface element (e.g., a word or words).

MEMORY MANAGEMENT SYSTEM 206. Memory management system (MMS) 206 is a module capable of processing interaction data collected from event tracking engine 206 and storing that data in knowledge database 218. MMS 206 runs on a client but those skilled in the art know that MMS 206 may run on central system 102, as desired. MMS 206 may handle and avoid conflicts, run batches and optimize memory.

EVENT TRACKING ENGINE 208. Event tracking engine 208 is a module capable of tracking certain user events or interactions by monitoring the position of an input cursor or device, such as a mouse, as representative of user interaction (and boundaries). Event tracking engine 208 may communicate with memory management system 206 for event management and processing and subsequent storage in knowledge database 218.

USER INTERFACE 210. User interface 210 is a module capable of determining user intent in order to create a window of particular content for user interaction. Specifically, UI 210 may define the boundaries of a region around which a user may not stray with the mouse, the time within the region and the movement or speed of the mouse to determine the intent of a user action.

PARSING SYSTEM 212. Parsing system 212 is a module capable of analyzing and identifying parts of a sentence or string of characters in order to associate groups of characters with syntactic units of the underlying grammar. According to one example, a sentence in Chinese is broken down into discrete parts of data that are known parts of the knowledge graph and those that are not. The knowledge graph may provide associations between multiple knowledge objects, or relations within a knowledge object. A typing recognition engine may recognize typed characters and may validate with the knowledge engine to determine the relationship between the typed text and the words analyzed by the knowledge engine and stored in the knowledge database. Parsing system 212 may augment known words or parts and may be capable of working with non- known words. Parsing system 212 may employ a natural language processing engine to perform these tasks. Parsing system 212 may use additional translation platforms to retrieve more information or meaning on words it does not know. For example, “brown” and “grey” are tied to knowledge objects (representations) in the knowledge engine. Knowledge objects present in the knowledge engine may create a map or association of keys and values, which may be stored in various formats on disk.

MARKETS TAB 214. Markets tab 214 is a module capable of selecting and managing user expert assistance. Markets tab 214 may record text or a user's voice in a desired language and then determine all the native language online speakers (“experts”) of that desired language and allocate tasks to those speakers for feedback to the user. A speaker or expert who is using platform 200 (learning another desired language) may receive a tooltip as part of a quiz window or other mechanism (below) as an option to act or function as an expert for another user. A plugin, or other feature understood by a person of ordinary skill in the art, may be used in a browser window that can present a menu giving users the option to teach others on a larger scale. Crowdsourcing specific user's needs to learn language may be used. Time limits may be employed. In sum, markets tab 214 may determine online experts and pair them with the non- expert users. According to an exemplary embodiment, experts may be selected based on online availability, past history as an expert, ratings from other users, previous quality of translation and/or speed. Corrections to words and sentences may be tracked and a database will be created with these corrections. This database may be part of the knowledge database 216 or another database, as would be understood by a person having ordinary skill in the art. As time progresses, this database may include virtually all corrections, whereby expert involvement may no longer be needed. Experts may assist with or without payment.

USER REGISTRATION ENGINE 216. User registration 216 may enable users to register and use platform 200.

KNOWLEDGE DATABASE 218. Knowledge database 218 is a database, as known to those skilled in the art, that may be capable of storing user interactions, also known as events, tracked by event tracking engine 208 and processed by MMS 206. Knowledge engine 202 may communicate with knowledge database 216 to gain access to its data.

USER DATABASE 220. User database 220 is a database or part of a broader database, as known to those skilled in the art, for storing registered user credential information.

As described above, FIG. 2 depicts a particular embodiment of platform 200, but those skilled in the art may understand that any number of modules and/or databases (or combinations thereof) may be employed for desired results, so long as the code and data required to perform the steps described herein is provided on the modules, databases, and/or combinations thereof. For example, according to some alternative embodiments, knowledge engine 202 and event tracking engine 208 may be combined as they work so closely together. MMS 206 may also be combined with knowledge engine 202 and event tracking engine 208.

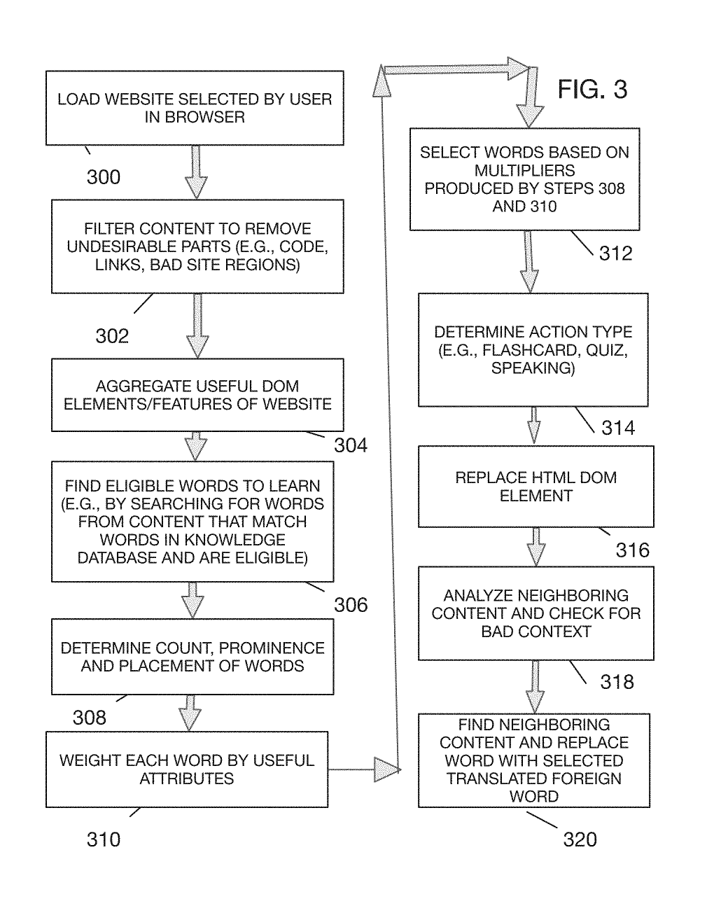

FIG. 3 depicts a flow diagram of method steps for the operation of intelligent language learning platform 200. In particular, execution may begin with step 300 wherein a website is loaded in a browser by a user. Execution may proceed to step 302 wherein the HTML content in the website is filtered to remove undesirable parts such as code, links and bad site regions. That is, platform 200 may find useless regions and features for subsequent processing of non-useful regions and features.

Execution may then proceed to step 304 wherein useful document object model (DOM) elements/features of the website page are aggregated.

Execution may proceed to step 306 wherein eligible words to be learned are uncovered. This may be accomplished by knowledge engine 202, whereby it searches for words from the content that match words in the knowledge database 218 and are eligible.

Execution may proceed to step 308 wherein the count, prominence and placement of words from the content are determined. This determination may act as a weighting value or multiplier A for each word for subsequent use.

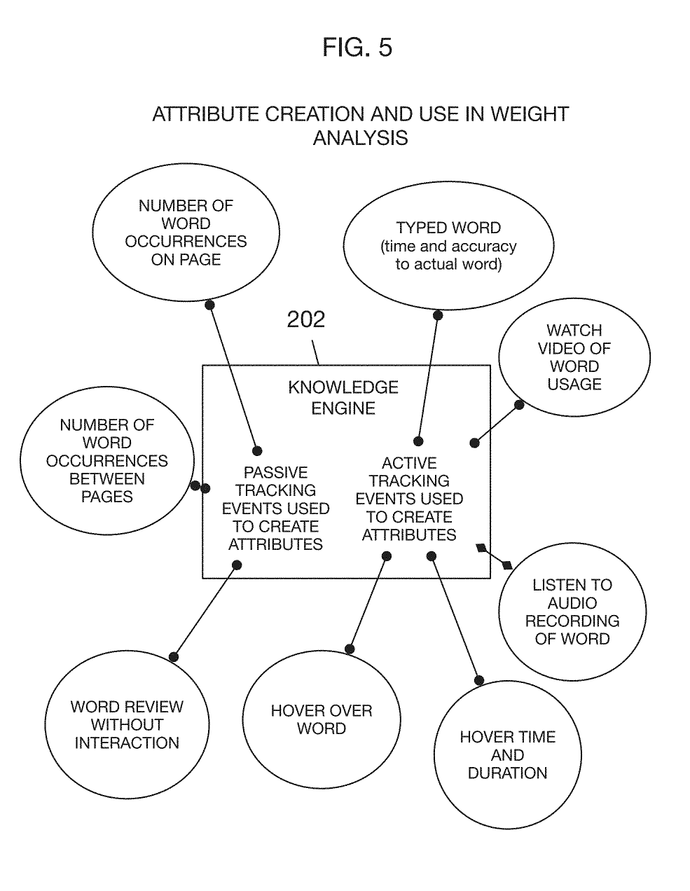

Execution may proceed to step 310 wherein each word is weighted (multiplied) by each useful attribute (weight value) created by knowledge engine 202 based on active tracking events (for user interactions) and passive tracking events (e.g., word occurrences) tracked by event tracking engine 208. The attribute values constitute a multiplier B, i.e., a weight based on attribute importance. These attributes are shown in FIG. 5. Example attributes include the number of word occurrence on the webpage and the number of word occurrences between pages. Additional example attributes are described in more detail below with respect to FIG. 5.

Execution proceeds to step 312 wherein words are selected for replacement on a webpage based on multipliers produced in steps 308 and 310. According to some exemplary embodiments, the number of words selected for replacement may be limited, such as by predetermined preferences or a percentage of the content in which they are contained, as would be understood by a person having ordinary skill in the art.

Next, execution may proceed to step 314 wherein a learning action is determined, i.e., to determine whether to display the word, flashcard, quiz, sentence or speaking request (to name a few).

Following, execution may proceed to steps 316-320 wherein word replacement is performed. Specifically, the HTML DOM element may be replaced and neighboring content may be analyzed. Bad context may also be checked. Finally, neighboring content is found and may optionally be edited or replaced to maintain context for the word selected for foreign word translation. That is, the platform 200 may essentially flip the original word for the new translated word. Execution may then end.

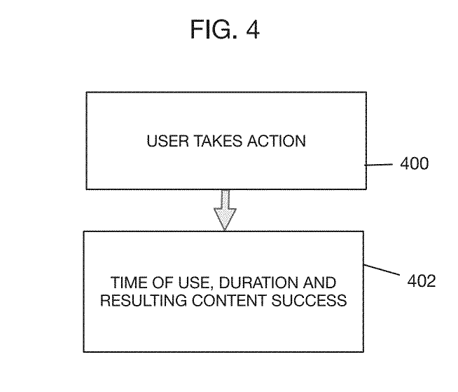

FIG. 4 depicts a high-level flow diagram of method steps of a user in connection with the method steps in FIG. 3. In particular, execution may proceed to step 400 wherein a user takes an action with respect to the presentation of a word or quiz. A window may open with various options for further action or activity.

Execution may proceed to step 402 wherein event properties, such as time of use, duration and resulting content success are detected and stored in knowledge database 218. (Each event has this information attached to it.)

FIG. 5 depicts a diagram illustrating attributes, as identified above with respect to FIG. 3, created by knowledge engine 202 of the intelligent language learning platform 200. Knowledge engine 202 may create one or more attributes from the data collected and processed by event tracking engine 208. Both passive tracking and active tracking may be performed. (Event tracking is automatic and doesn't make logic decisions on what to show or modify within content.) Active tracking of user interaction may include (1) typed words (both time and accuracy to actual word), (2) video viewed (activated), (3) audio recording play, (4) hover over a word, and (5) hover time and duration (over a word etc.). Passive tracking may include (1) the number of word occurrences on a page, (2) the number of word occurrences between pages and (3) a word review without any real user interaction such as reading. Knowledge engine 202 may process all of the data from both passive and active tracking to create a number of attributes that are used in the method shown in FIG. 3.

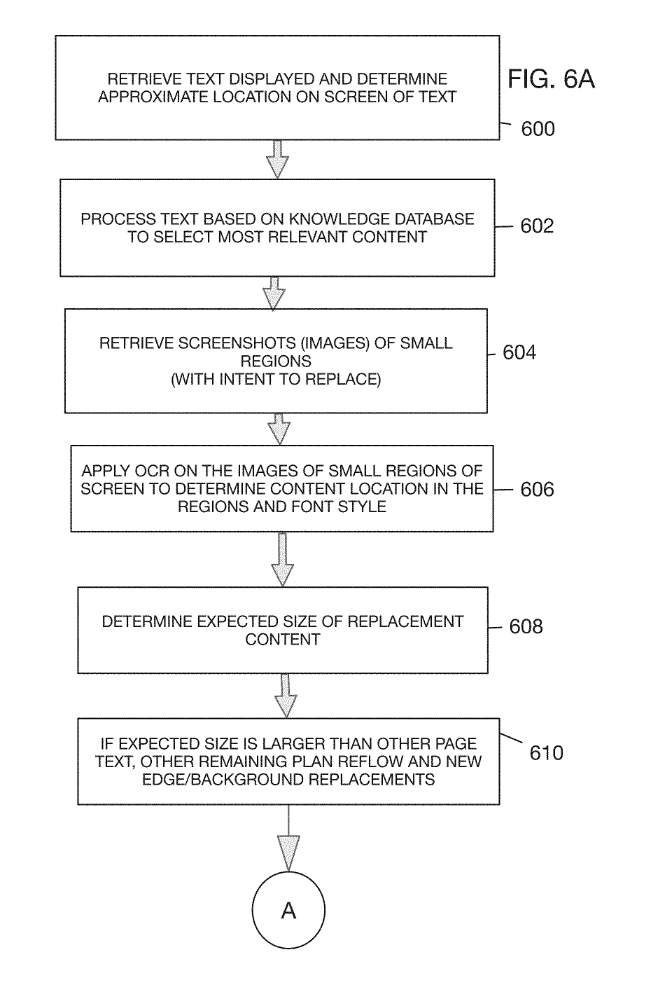

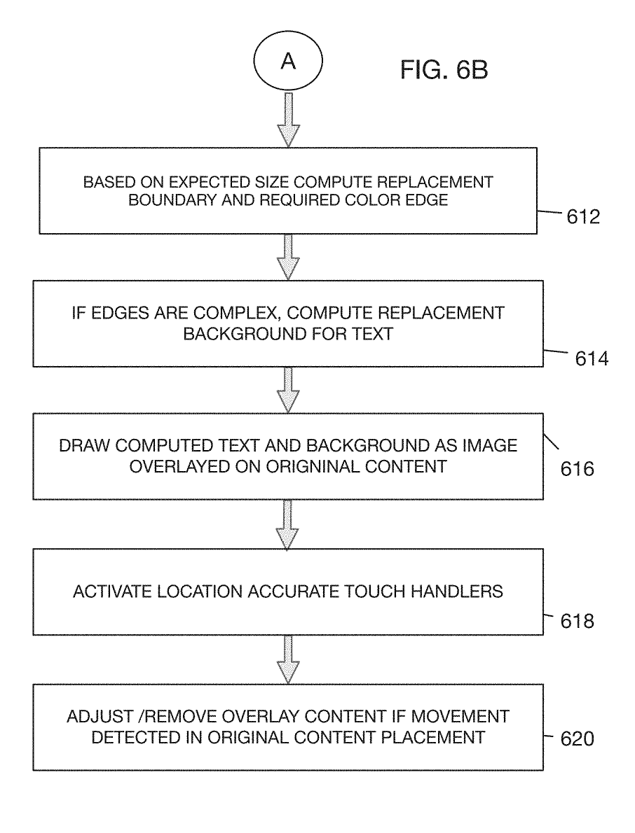

FIGS. 6A-6B depict a flow diagram of the method steps for operation of an exemplary embodiment of the intelligent language learning platform on a mobile device. In particular, execution may proceed to step 600, wherein screen contents of any active application displayed on a device may be accessed. All displayed text may be retrieved from the accessed content and approximate on screen location of the displayed text may be determined.

Execution may proceed to step 602 wherein text may be processed based on data from the knowledge database in order to select the most relevant content. Natural Language Processing may be used to find words or phrases in the screen content that are relevant to a user, based on data from the knowledge database. If the number of relevant or useful words or phrases is below a pre-set threshold, execution may end. Non-useful text fragments may be removed from the retrieved text.

Execution may then proceed to step 604 wherein screen images of the mobile device screen are retrieved. These screen images may be small regions of the screen including relevant or useful words or phrases.

Execution may proceed to step 606 wherein OCR is applied to the screenshot images to determine properties or attributes of content in the regions, such as location, size, and font style. OCR may be used to determine matching content location. OCR may further be used to find specific pre-determined words, which may improve algorithm performance.

Execution may proceed to step 608 wherein the expected size of the replacement content and an exact location for the replacement content may be determined (by parsing system 212) using the OCR results. Platform 200 may calculate or estimate the size of the replacement word, for example, at this point.

Execution may proceed to step 610 wherein, if the expected size is larger than the boundaries for such text, plan reflow and a new edge/background for the replacement content are calculated. That is, if a translated word or phrase is too large, platform 200 may recalculate surrounding text, background and edges. According to an exemplary embodiment, if a replacement word or phrase is larger than the originally available space, a screenshot image and OCR may be used to determine what content must be moved to fit the replacement word or phrase and the necessary location data to effect the move.

Execution may proceed to step 612 wherein, based on the expected size, the replacement boundary and required color edge is computed. Content colors may be retrieved from the original screen image to create replacement boundaries and edges. The background of the overlaid image may be filled with a solid color, smoothed gradient, images, patterns or smart fill, as would be understood by a person having ordinary skill in the art.

Execution may proceed to step 614 wherein, if the edges are complex, (i.e., as a result of varying color for example), the replacement background for the text is computed.

Execution may proceed to step 616 wherein the computed text and background is overlaid as an image over the original content. A user interface element may be created with the new background and text and may be placed in a determined position.

Execution may proceed to step 618 wherein accurate touch handlers are activated, creating an active region on the overlaid image which may be engaged by a user when touched, clicked, or otherwise engaged, as would be understood by a person having ordinary skill in the art.

Execution may proceed to step 620 wherein the text overlay is adjusted/removed if movement of the content being overlaid is detected. That is, if a page starts to move, the overlay image (content) will have to move accordingly or it will be removed and then replaced when page movement ceases. Replaced element details may be retained for now-offscreen elements. Each UI element may be moved independently to a new location. Furthermore, the data may be stored in an efficient, unique hash to increase performance for quick updates, such as scrolling.

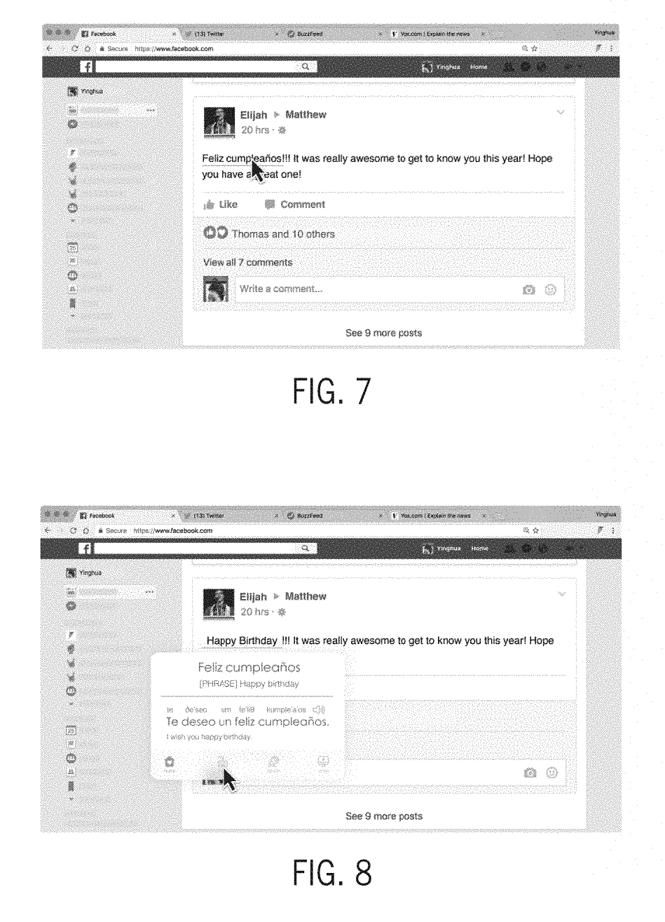

FIGS. 7-15 depict several screenshots illustrating various exemplary webpages incorporating features of the intelligent language learning platform 200.

In particular, FIG. 7 depicts an exemplary webpage wherein a replaced phrase (English into Spanish) in shown.

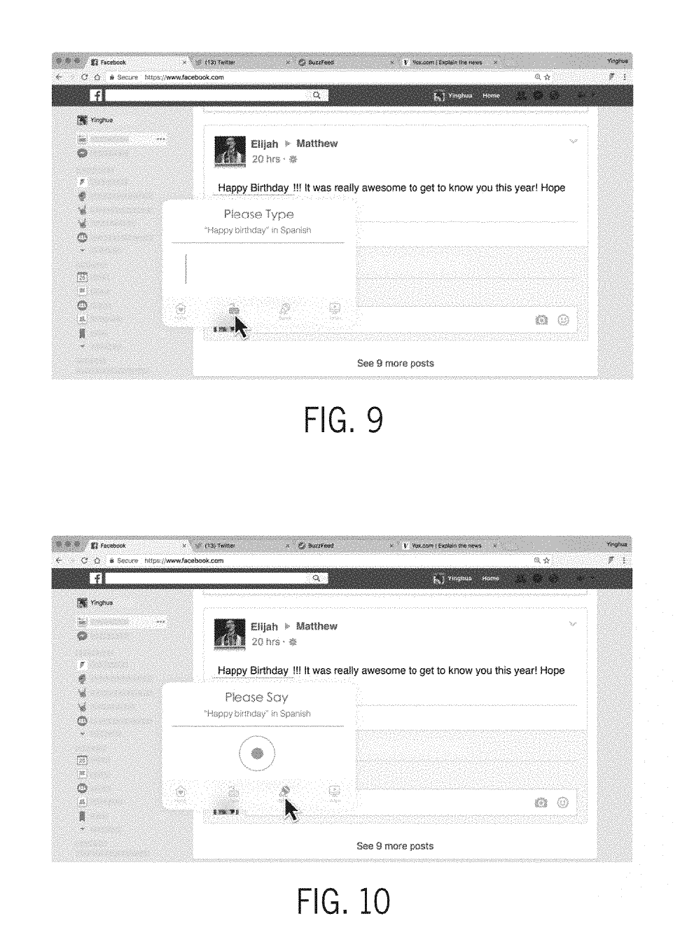

FIG. 8 depicts an exemplary webpage wherein a tooltip (popup window) appears with information and user options when a user has hovered over the replaced word for a specified duration. In addition, the original phrase may re-appear. The user/cursor in FIG. 8 is hovering over a type tab (keyboard icon) in the window from where the user may enter the Spanish word as practice as shown in FIG. 9. In some embodiments, the user may type directly to switch to a typing tab.

FIG. 9 is similar to that depicted in FIG. 8. FIG. 9 depicts an exemplary webpage wherein a tooltip (popup window) appears with information and user options when a user has hovered over the typing tab (icon) for a specified duration or actually clicked on it.

FIG. 10 depicts an exemplary webpage wherein a popup window appears with information and user options when a user has hovered over a speaking tab (icon) for a specified duration or actually clicked on it. In this example, the user has activated the speaking tab (icon) whereby it begins recording a user's voice automatically after a short countdown.

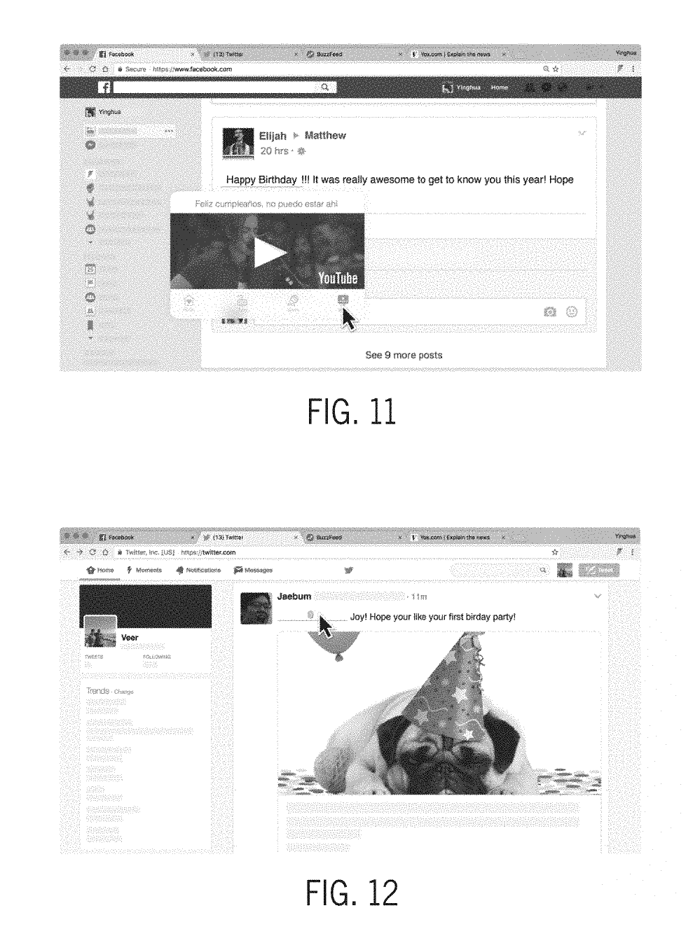

FIG. 11 depicts an exemplary webpage wherein a popup window appears with information and user options when a user has hovered over a video tab (icon) for a specified duration or actually clicked on it. In this example, a video is about to play containing the word or phrase to be learned.

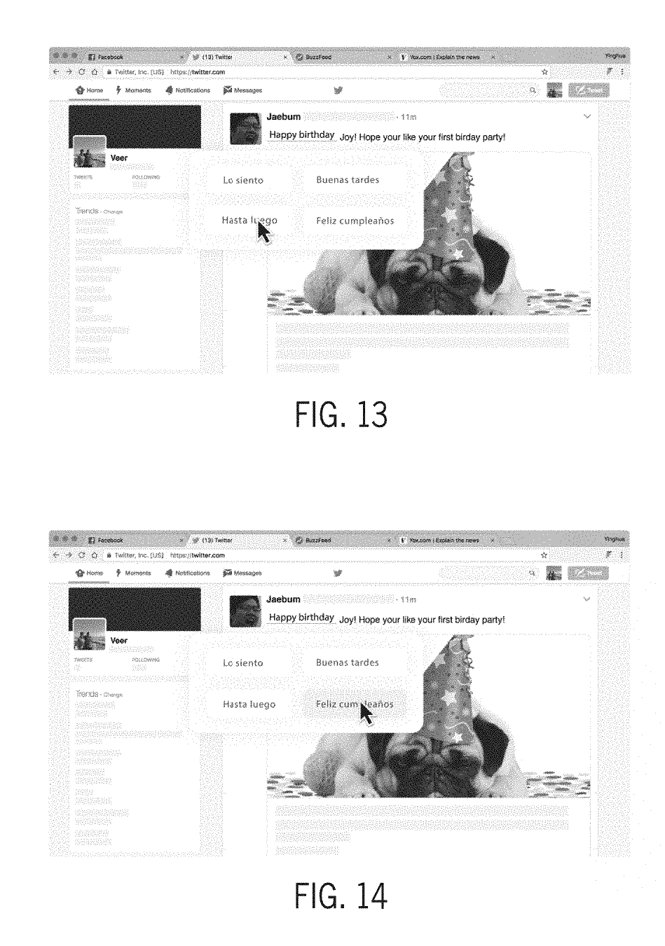

FIG. 12 depicts an exemplary webpage wherein a word is replaced with an active symbol, e.g., coin, representing a test or quiz for the user. A user may hover over the symbol and a quiz/test may appear for the user as shown in FIG. 13. In this example, several Spanish words appear as multiple choice options for the underlined word “Happy birthday.”

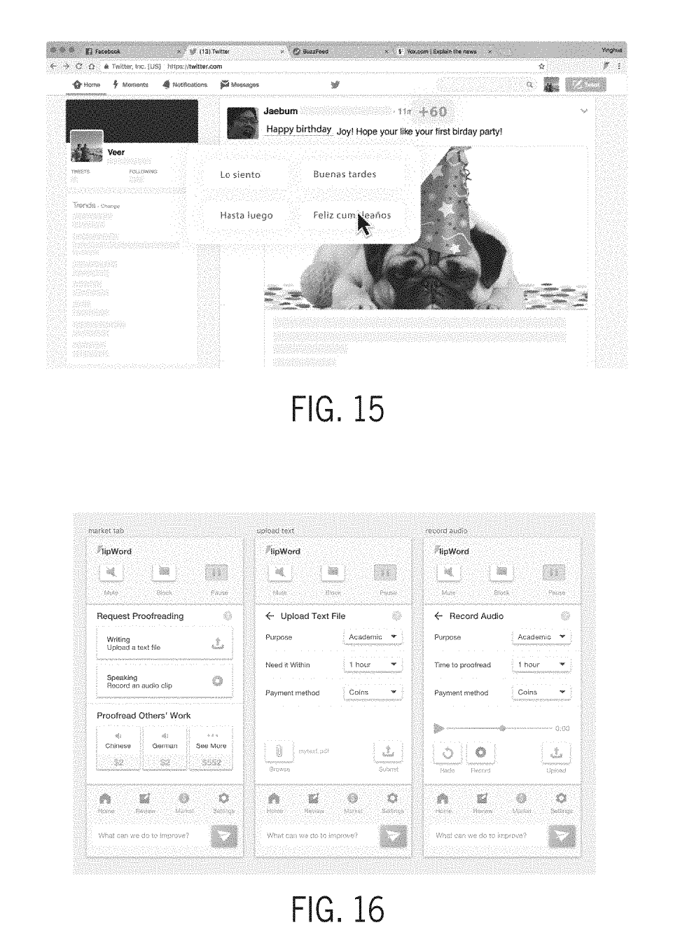

FIG. 14 depicts an exemplary webpage wherein a user hovers over a particular selection in the popup window completing the test. FIG. 15 depicts a screenshot wherein the user receives points for the correct selection (60 points in this example).

In a quiz context, platform 200 may analyze page content based on usage history, determine relevant learning content to add to “quiz” and create a “quiz” based on original page content.

FIG. 16 depicts the flow for an exemplary embodiment of an expert user grading market. The market tab (first screen) is a launch point, from where a non-native speaker can submit text or an audio recording for a native speaker of the language to correct and give feedback. The second screen shows some options for allowing the user to set the user's priority, intent, payment method, and upload their document. The third screen allows recording directly or uploading of an audio file instead of document uploading. The first screen also shows available tasks from other non- native speakers of your native language, in order to give feedback and possibly earn rewards.

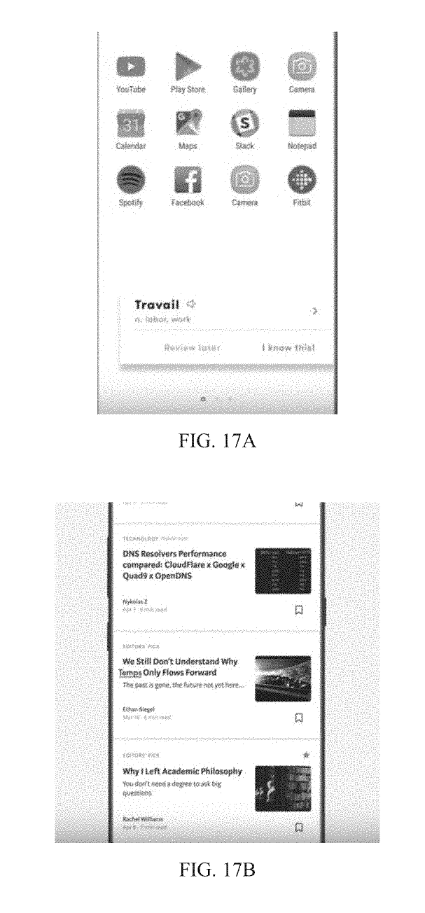

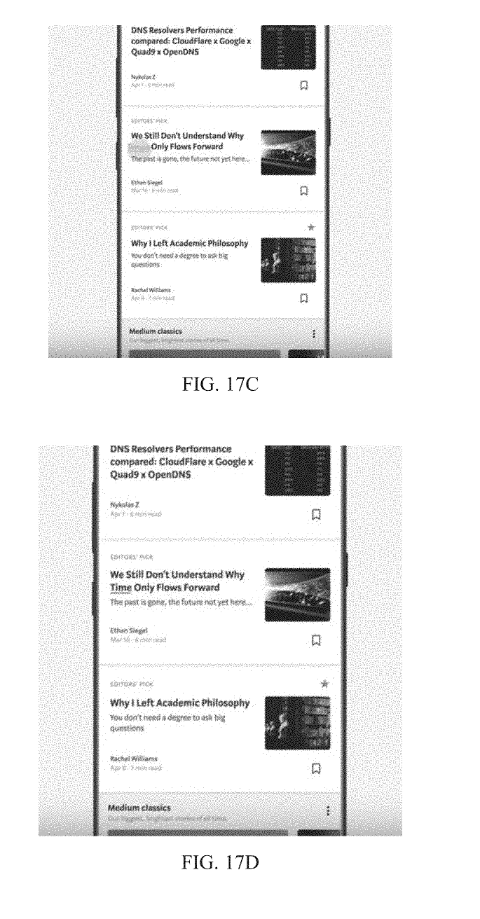

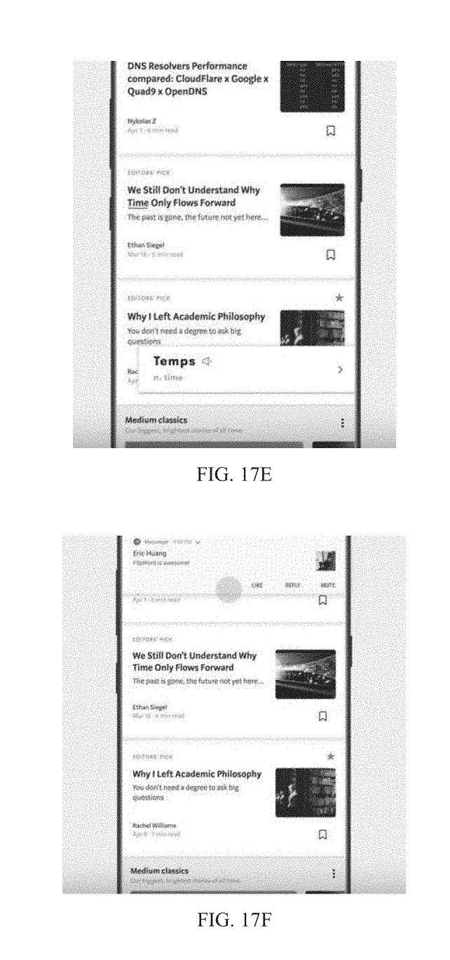

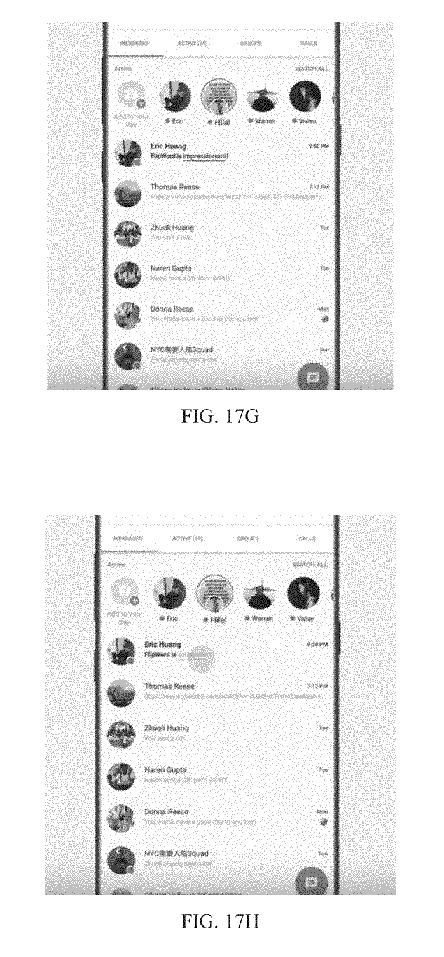

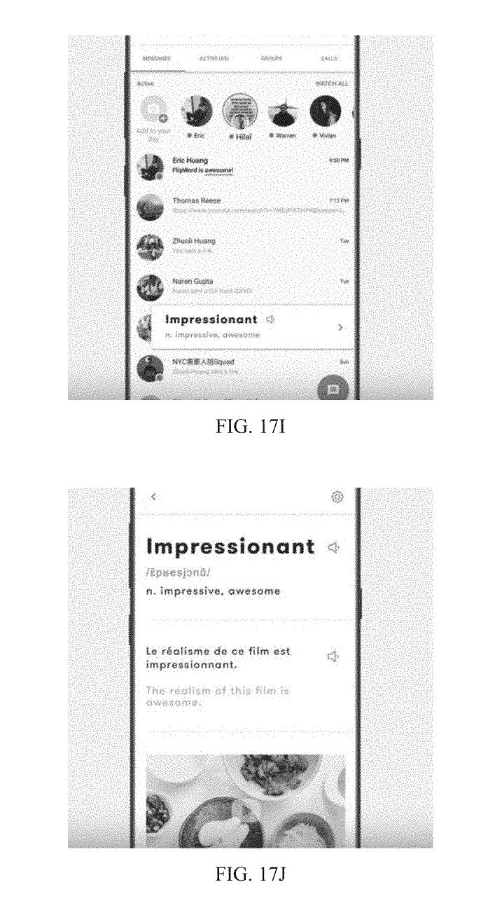

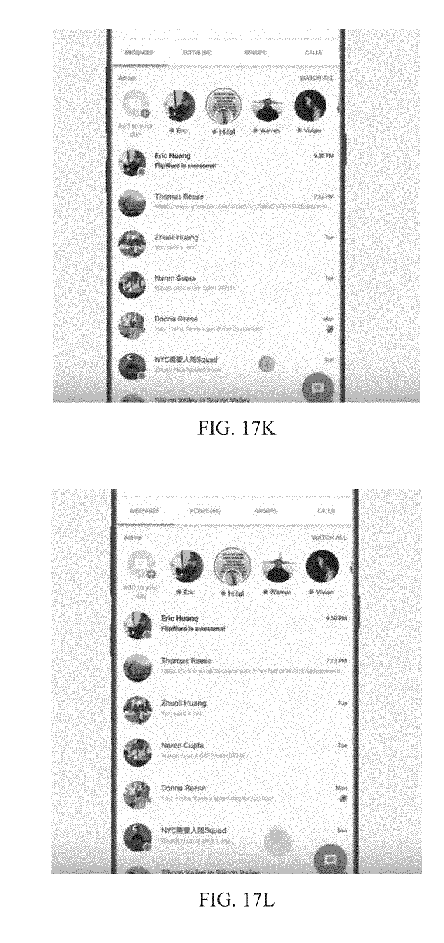

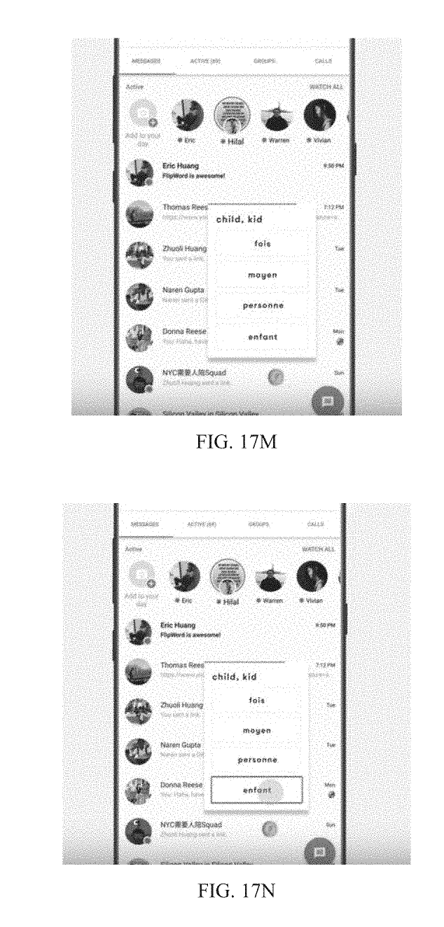

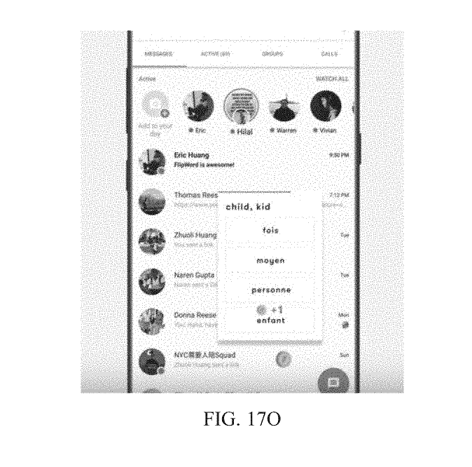

FIGS. 17A-17O show a series of screen representations demonstrating exemplary functionality of the intelligent language learning platform as described herein.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for providing an intelligent language learning platform comprising:
accessing content displayed on a device screen;
retrieving text and adjacent content on the device screen;
retrieving location data for the retrieved text and adjacent content;
comparing retrieved text to a database comprising at least one of user data and target words or phrases;
identifying at least one target word or phrase based on the comparison;
capturing an image of the at least one target word or phrase and adjacent content;
editing the image to replace the text of the at least one target word or phrase, which is presented in a first language, with text translated into a second language;
overlaying the edited image on the content displayed on the device screen to show the text of the at least one target word or phrase in the second language.

2. The method of claim 1, wherein the process is terminated if the number of target words or phrases in the accessed content is below a pre-determined threshold.

3. The method of claim 1, wherein the overlaid content comprises an active region to initiate an action when engaged by a user.

4. The method of claim 3, wherein the action comprises at least one of reading the word or phrase, showing the word or phrase in the original language, presenting a quiz, or requesting user entry.

5. The method of claim 3, wherein the active region aligns with the at least one translated word or phrase.

6. The method of claim 1, further comprising calculating boundaries of replacement text, retrieving data for background content surrounding the text boundaries within the captured image and adjacent to the captured image, adjusting the background content of the edited image to match original background content and blend with the content adjacent to the overlaid image.

7. The method of claim 1, wherein the location of displayed content elements is tracked and the overlaid image is adjusted to match changes in displayed content location.

8. The method of claim 1, wherein a knowledge engine records and interprets user specific data to individually weight target words and teaching actions.

9. The method of claim 8, wherein the knowledge engine selects content to display and accompanying teaching actions using weight values.

10. A non-transitory computer-readable medium for providing an intelligent language learning platform, comprising instructions stored thereon, that when executed on a processor, perform the steps of:
accessing content displayed on a device screen;
retrieving text and adjacent content on the device screen;
retrieving location data for the retrieved text and adjacent content;
comparing retrieved text to a database comprising at least one of user data and target words or phrases;
identifying at least one target word or phrase based on the comparison;
capturing an image of the at least one target word or phrase and adjacent content;
editing the image to replace the text of the at least one target word or phrase, which is presented in a first language, with text translated into a second language;
overlaying the edited image on the content displayed on the device screen to show the text of the at least one target word or phrase in the second language.

11. The non-transitory computer-readable medium of claim 10, wherein the process is terminated if the number of target words or phrases in the accessed content is below a pre-determined threshold.

12. The non-transitory computer-readable medium of claim 10, wherein the overlaid content comprises an active region to initiate an action when engaged by a user.

13. The non-transitory computer-readable medium of claim 12, wherein the action comprises at least one of reading the word or phrase, showing the word or phrase in the original language, presenting a quiz, or requesting user entry.

14. The non-transitory computer-readable medium of claim 12, wherein the active region aligns with the at least one translated word or phrase.

15. The non-transitory computer-readable medium of claim 10, further comprising calculating boundaries of replacement text, retrieving data for background content surrounding the text boundaries within the captured image and adjacent to the captured image, adjusting the background content of the edited image to match original background content and blend with the content adjacent to the overlaid image.

16. The non-transitory computer-readable medium of claim 10, wherein the location of displayed content elements is tracked and the overlaid image is adjusted to match changes in displayed content location.

17. The non-transitory computer-readable medium of claim 10, wherein a knowledge engine records and interprets user specific data to individually weight target words and teaching actions.

18. The non-transitory computer-readable medium of claim 17, wherein the knowledge engine selects content to display and accompanying teaching actions using weight values.
